(19) United States
(12) Patent Application Publication
(10) Pub. No.: US 2012/0182373 A1
(43) Pub. Date: Jul. 19, 2012

(54) OPTICAL SCANNING DEVICE AND IMAGE FORMING APPARATUS

(76) Inventor: Yoshinori HAYASHI, Kanagawa (JP)

(21) Appl. No.: 13/349,250

(22) Filed: Jan. 12, 2012

(30) Foreign Application Priority Data
Jan. 13, 2011 (JP) 2011-004978

(51) Int. Cl. B41J 2/435; G02B 26/08

(52) U.S. Cl. 347/224; 359/204.1

(57) ABSTRACT

An optical scanning device for an image forming apparatus includes plurality light sources, a deflecting unit that deflects light beams from the light sources with a common deflecting reflection surface, a scanning optical system that guides the light beams deflected from the common deflecting reflection surface of the deflecting unit onto the optical scanning portions on stations different for each light source in order to form an optical spot with each light beam, monitoring units that monitor light intensities of the light beams from the light sources, and a splitting unit that splits each light beam into a split light beam toward one monitoring unit. The light beams enter the monitoring unit at different timings and enter the deflecting unit at different incident angles.

### CROSS-REFERENCE TO RELATED APPLICATIONS

The present application claims priority to and incorporates by reference the entire contents of Japanese Patent Application No. 2011-004978 filed in Japan on Jan. 13, 2011.

### BACKGROUND OF THE INVENTION

1. Field of the Invention

The present invention relates to an optical scanning device and an image forming apparatus.

2. Description of the Related Art

Image forming apparatuses are well known in which light beams from N (N is an integer more than 1) light sources are deflected with a common polygon mirror, the deflected light beams are guided to different stations corresponding to the light sources, writing is performed by optical scanning of optical scanning portions of the respective stations, and toner images formed on the respective stations are superimposed so that a color image or a multicolor image is obtained.

Among optical scanning devices that can increases the image forming speed in such image forming apparatuses, optical scanning devices using a multi-beam scanning system are known that are designed to use “surface-emitting lasers including a plurality of light emitting elements” as their light sources.

A surface emitting laser is formally referred to as “a vertical cavity surface emitting laser” and normally abbreviated to “VCSEL”.

A surface emitting laser is a “semiconductor laser that emits laser light in a direction orthogonal to the substrate”. Thereby, it is possible to arrange the light emitting elements in two-dimensional array (two-dimensional integration), and thereby realize the laser including multiple light emitting elements. The power consumption of a surface emitting laser is smaller than that of an edge emitting laser by approximately an order of magnitude, which is advantageous when integrating additional light emitting elements.

However, since the surface emitting laser “emits light beams in a single direction orthogonal to the active layer”, it is difficult to control the light intensity or light volume by using automatic power control (hereinafter, “APC”).

With a conventional edge emitting LD array, which is known as a light source in optical scanning devices that use a multi-beam scanning system, a “simple light intensity monitoring in which back light is monitored” can be performed. However, as for a surface emitting laser, since the emission of laser light is limited to being in a “single direction orthogonal to the active layer”, a “light intensity monitoring using back light” cannot be performed.

For a light scanning device using a surface emitting laser as a light source, it is proposed that part of the laser light emitted from the surface emitting laser is caused to split as “monitor light” and is detected by an optical detector (Japanese Patent Application Laid-open No. 2006-103248).

In Japanese Patent Application Laid-open No. 2006-103248, the APCs of VCSELs for plurality stations are performed with using a common PD (Photodetector), for the purpose of reducing the device size, reducing the number of components, and reducing the effect due to the variation in properties of PDs for respective devices, and thereby improving the accuracy of APC.

However, when the PD for APC is shared in this configuration, “the time domain in which APC can be performed” is limited, which reduces “the frequency of APC and the time period for performing APC”.

If the frequency of APC is reduced and the time period for performing APC is shortened, the accuracy in correcting the temperature variations in the optical scanning device and “the change of the temperature of the VCSELs due to the VCSEL driver circuit or light emissions by the VCSELs” deteriorates. This causes density variation and a color difference in the formed image.

A method of monitoring the intensity of light from a surface emitting laser is also proposed in Japanese Patent Application Laid-open No. 2002-026445.

### SUMMARY OF THE INVENTION

It is an object of the present invention to at least partially solve the problems in the conventional technology.

An optical scanning device is for an image forming apparatus to form an image by superimposing toner images formed via optical scanning with respect to optical scanning portions on stations. The device is provided with: a light source unit including N surface emitting lasers as light sources each including M light emitting elements, wherein N is an integer more than 1 and M is an integer more than 1; a deflecting unit that deflects light beams from the light sources with a common deflecting reflection surface; a scanning optical system that guides the light beams deflected from the common deflecting reflection surface of the deflecting unit onto the optical scanning portions on stations different for each light source in order to form an optical spot with each light beam; one or more monitoring units that monitor light intensities of the light beams from the light sources corresponding to N surface emitting lasers; and a splitting unit that splits the light beams, a part of which is to be deflected with the common deflecting reflection surface of the deflecting unit, into split light beams toward one monitoring unit. The one monitoring unit monitors the light intensities of the light beams from two or more light sources to be deflected with the common deflecting reflection surface of the deflecting unit, the light beams from two or more light sources of which light intensities are monitored by the one monitoring unit enter the common deflecting reflection surface of the deflecting unit with different incident angles in a main scanning direction cross section plane, and the light beams from two or more light sources of which light intensities are monitored by the one monitoring unit enter the one monitoring unit at different timings from each other.

According to the above optical scanning device, a “timing when an Automatic Power Control may be started” differs between the light sources of which light intensities are monitored by the one monitoring unit.

According to the above optical scanning device, the monitoring unit which monitors the light intensities of the light beams from two or more light sources may include the “splitting unit” and a “common collecting lens” that collects the light beams split from the splitting unit, and the light beams may enter a light receiving surface of the one monitoring unit with diverging, after the light beams are collected at the collecting lens before the light receiving surface of the monitoring unit in a main scanning direction.

According to the above optical scanning device, preferably “the light beams overlap with each other on the light receiving surface of the monitoring unit, when entering the light receiving surface of the monitoring unit via the collecting lens”.

According to the optical scanning device, preferably “the light beams from two or more light sources of which light intensities are monitored by the one monitoring unit enter the light receiving surface of the one monitoring unit with different incident angles for each light source in a sub scanning direction cross section plane”.

A multi-color-compatible image forming apparatus is to form an image by superimposing toner images formed via optical scanning with respect to optical scanning portions on stations. The apparatus is provided with an optical scanning device including: a light source unit including N surface emitting lasers as light sources each including M light emitting elements, wherein N is an integer more than 1 and M is an integer more than 1; a deflecting unit that deflects light beams from the light sources with a common deflecting reflection surface; a scanning optical system that guides the light beams deflected from the common deflecting reflection surface of the deflecting unit onto the optical scanning portions on stations different for each light source in order to form an optical spot with each light beam; one or more monitoring units that monitor light intensities of the light beams from the light sources corresponding to N surface emitting lasers; and a splitting unit that splits the light beams, a part of which is to be deflected with the common deflecting reflection surface of the deflecting unit, into split light beams toward one monitoring unit. The one monitoring unit monitors the light intensities of the light beams from two or more light sources to be deflected with the common deflecting reflection surface of the deflecting unit, the light beams from two or more light sources of which light intensities are monitored by the one monitoring unit enter the common deflecting reflection surface of the deflecting unit with different incident angles in a main scanning direction cross section plane, and the light beams from two or more light sources of which light intensities are monitored by the one monitoring unit enter the one monitoring unit at different timings from each other.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an embodiment of an optical scanning device;

FIG. 2 is a diagram illustrating another embodiment of the optical scanning device;

FIGS. 3A and 3B are diagrams illustrating a characteristic of the invention;

FIG. 4 is a diagram illustrating another characteristic of the invention;

FIG. 5 is a diagram illustrating a further characteristic of the invention;

FIG. 6 is a diagram illustrating another embodiment of the optical scanning device; and

FIG. 7 is a diagram illustrating an embodiment of an image forming apparatus.

### DETAILED DESCRIPTION OF THE PREFERRED EMBODIMENTS

Embodiments will be described below.

In an embodiment, the “light source unit” includes, as light sources, N surface emitting lasers each including M light emitting elements. In this context, N is an integer more than 1 and M is an integer more than 1. In other words, one light source is a “surface emitting laser” corresponding to “one station”. The surface emitting laser includes two or more light emitting elements. Accordingly, multi-beam scanning is performed using “M light spots” on the optical scanning unit of each of the stations.

In an embodiment, a “scanning optical system” guides the light beams, which are deflected by a common deflecting unit, to optical scanning portions of the different stations corresponding to the light sources, so that the light beams form light spots, respectively. In other words, one scanning optical system is provided for “each station”. However, part of two or more optical devices constituting a scanning optical system can be shared by optical scanning systems for two or more stations.

In an embodiment, the “monitoring unit” is for monitoring the light intensities of the light beams from two or more light sources (N surface emitting lasers) and is used more than one in its numbers. One monitoring unit monitors the light intensities of “the laser beams from two or more light sources to be deflected with the common deflecting reflection surface of the deflecting unit”.

In an embodiment, the “splitting unit” diverts a part of the light beams to the common monitoring unit. The remaining part of the light beams is deflected with the common deflecting reflection surface of the deflecting unit such as polygon mirror.

In an embodiment, the light beams from “two or more light sources, of which light intensities are monitored by the common monitoring unit (i.e. light sources share the monitoring unit)”, enter the common deflecting reflection surface of the deflecting unit such as polygon mirror with different incident angles in the “main scanning direction cross section plane”.

In an embodiment, the light beams from two or more light sources sharing the monitoring unit enter the monitoring unit at different timings from each other.

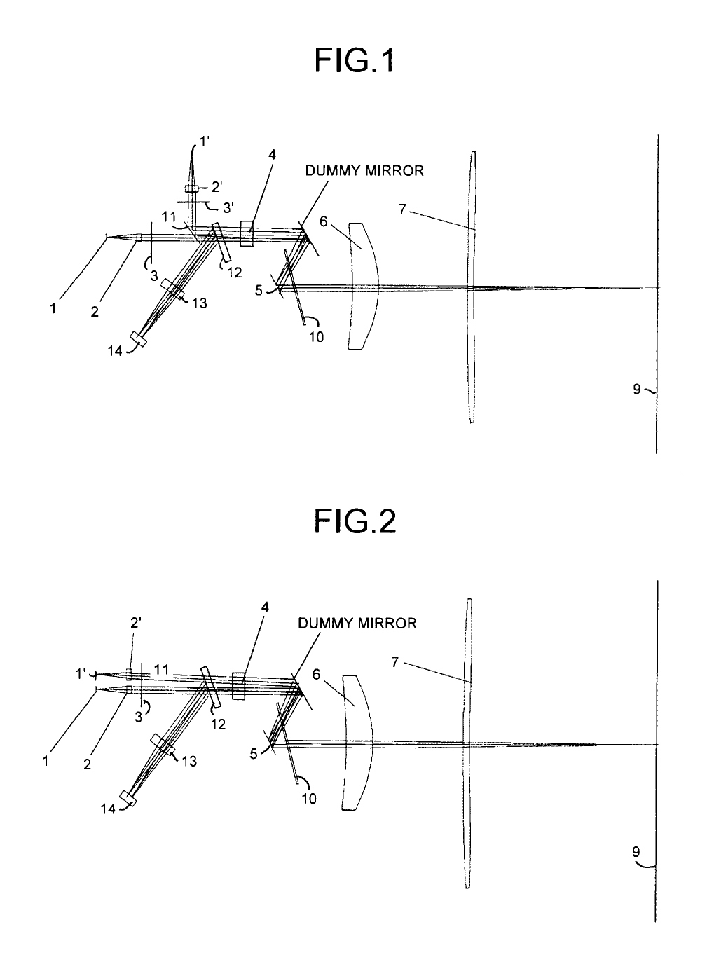

FIG. 1 shows an embodiment of an optical scanning device.

Light sources 1, 1′ are surface emitting lasers (VCSEL) in which a plurality of light emitting elements are arrayed two-dimensionally. Thus, “a plurality of light beams” is emitted from each of the light source 1 and the light source 1′ but is described simply as “a light beam” below.

The divergence of the diverging or diffusing light beam that is emitted from the light source 1 is reduced through a coupling lens 2 to “a small divergence”, shaped through an aperture 3, and becomes through an anamorphic lens 4 “a parallel light flux in the main scanning direction” and “a light flux focused or collected near the deflection reflection surface of a polygon mirror 5 as deflecting unit in the sub-scanning direction”.

The light flux is then deflected according to rotation of the polygon mirror 5 and is then projected by the effects of scanning lenses 6 and 7 on an imaging surface 9 via a dust-proof glass 8 (not shown). A soundproof glass 10 is arranged between the polygon mirror 5 and the scanning lens 6. The “dummy mirror” in FIG. 1 inflects the optical path of the light beam and may be omitted depending on the layout of the optical system.

The light source 1 and the coupling lens 2 are fixed to “the same member made from an aluminum material”.

For the two-dimensional array of the light emitting elements in the light source 1 that is a surface emitting laser in which the light emitting elements are two-dimensionally arrayed, various array patterns are possible, such as an array of 40 light emitting elements (4 main direction×10 sub-direction), an array of 40 light emitting elements (10 main direction×4 sub-direction), and an array of 32 light emitting elements (8 main direction×4 sub-direction).

The interval between each light emitter needs to be determined in consideration of, in addition to the limitations on semiconductor manufacturing processes, the “influence of thermal interference from other light emitting elements during the operation of the array”.

In contrast, the divergence of the diverging or diffusing light beam that is emitted from the light source 1′ is reduced through a coupling lens 2′ to “a small divergence”, shaped through a aperture 3′, and becomes through an anamorphic lens 4 “a parallel light flux in the main scanning direction and a light flux focused or collected near the deflection reflection surface 5 of the polygon mirror in the sub-scanning direction”.

The light flux is then deflected according to the rotation of the polygon mirror and is then imaged by the effects of the scanning lenses 6 and 7 on the imaging surface 9 via the dust-proof glass 8 (not shown).

The scanning lenses 6, 7 that are in fact lens systems individually arranged for the light source 1 and the light source 1′ are drawn as a single lens system to simplify the drawing. Furthermore, the imaging surface 9 for the light source 1 and the imaging surface 9 for the light source 1′ are different.

In other words, although the imaging surface 9 is drawn as a single surface in FIG. 1, the imaging surface on which a light spot is formed by the light beam from the light source 1 and the imaging surface on which a light spot is formed by the light beam from the light source 1′ are optical scanning portions of different stations.

The light source 1′ and the coupling lens 2′ are fixed to “the same member made from an aluminum material”.

In FIG. 1, the light beam emitted from the light source 1 and the light beam emitted from the light source 1′ are separated from each other in the sub-scanning direction orthogonal to the drawing plane.

In the embodiment in FIG. 1, the light beam emitted from the light source 1′ is located posterior to the drawing plane.

The “width in the sub-scanning direction” of a mirror 11 is set so as to reflect only the “light beam from the light source 1′” and the light beam reflected by the mirror 11 and the light beam from the light source 1 have “small angles with respect to the main scanning direction”.

In the optical paths of the light beams, a half-mirror 12 serving as “a splitting unit” is arranged. The half-mirror 12 splits the light beam from the light source 1 and the beam from the light source 1′, and each of the light beams is focused or collected through the anamorphic collecting lens 13 on the light receiving surface of a monitoring PD 14.

As described above, since the light beam reflected by the mirror 11 and the light beam from the light source 1 have a “small angle with respect to the main scanning direction”, the light beam posterior to the drawing plane enters the deflection reflection surface 5 with an incident angle different from an incident angle of the light beam in or anterior to the drawing plane.

The polygon mirror rotates clockwise in FIG. 1 and the light beam from the light source 1′ is deflected according to the rotation of the polygon mirror prior to the deflection of the light beam from the light source 1.

If the station that is optically scanned by the light beam from the light source 1 is referred to as station A and the station that is optically scanned by the light beam from the light source A′ is referred to as station B, station B is optically scanned prior to optical scanning on station A.

Since there is a “time lag” between the optical scanning of station A and the optical scanning of station B, APC can be individually performed on the light sources 1 and 1′ by utilizing the time lag.

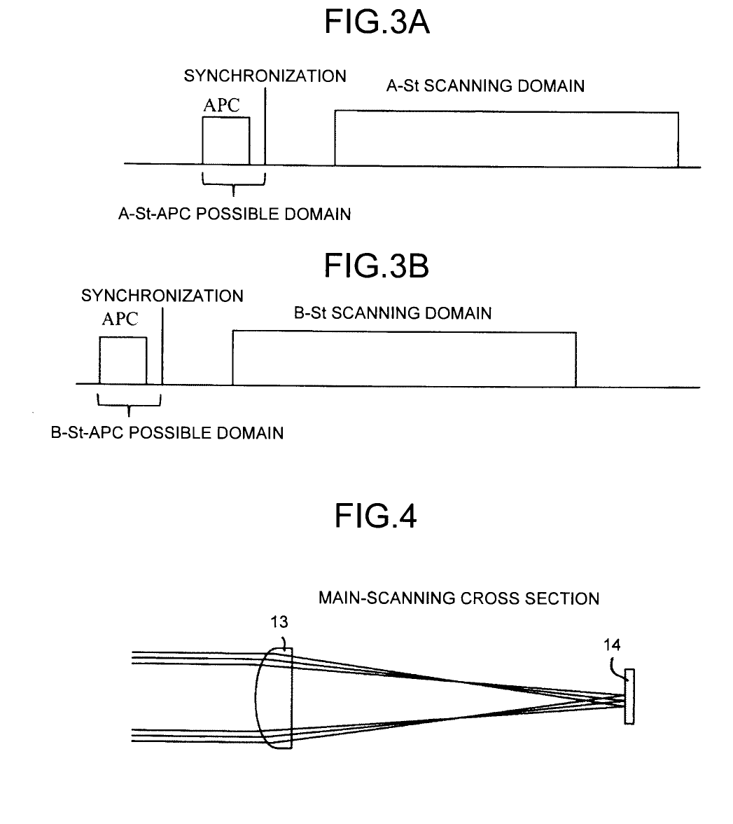

FIGS. 3A and 3B show a timing chart.

When optical scanning for optical writing is performed, the light source 1′ is first caused to emit light, the intensity of the light is detected or monitored by the monitoring PD 14, and APC is performed in the “B-St-APC possible domain” shown in FIG. 3B. During this process, the polygon mirror is constantly rotating and deflects the light beam from the light source 1′. It is detected that the deflected light beam travels toward an optical scanning start position. And, the synchronous detection is performed for an optical writing using the light beam from the light source 1′.

The light source 1′ is turned off in this state and, instead, the light source 1 is caused to emit light. The intensity of the light is detected by the monitoring PD 14, and APC is performed in the “A-St-APC possible domain” shown in FIG. 3A. It is detected that “the light beam from the light source 1” deflected by the polygon mirror travels toward an optical scanning start position. And, the synchronous detection is performed for an optical writing using the light beam from the light source 1.

Thereafter, image writing is performed by performing optical scanning using the light beam from the light source 1′ in a scanning domain (the B-St scanning domain in FIG. 3B) of the B station. Image writing is then performed by performing optical scanning using the light beam from the light source 1 in a scanning domain (the A-St scanning domain in FIG. 3B) of A station.

Since the “time allowed for APC” out of “the domain of image writing using optical scanning” is different between A station and B station, APC can be performed on A station and B station using the same scanning line for optically scanning both of the stations. Accordingly, the frequency of APC can be increased and a sufficient time for APC can be secured.

Accordingly, even if the temperature of the VCSELs varies due to variation of the temperature in the optical scanning device, the heat generated by the VCSEL driver circuit, and the heat generated by the VCSELs, the intensity of light can be corrected according to the variation of the temperature, which can reduce the occurrence of density unevenness and color difference.

The half mirror 12 used in this embodiment may have “a wedge-shaped cross section” to reduce variation in the intensity of light due to the etalon effect.

FIG. 2 shows another embodiment.

In this embodiment, instead of using the mirror 11 as in the embodiment in FIG. 1, the light sources 1 and 1′ are arranged on the same side (left side in FIG. 2) as that of the common aperture 3. The light source 1′ is arranged posterior to the light source 1 in a direction orthogonal to the drawing plane. The “incident angles in the main-scanning cross section plane when entering the deflection reflection surface of the polygon mirror” are different between the light beam from the light source 1 and the light beam from the light source 1′.

As it is performed in the embodiment illustrated in FIG. 1, the light intensity is monitored by splitting the light beams from the light sources 1, 1′ by the half mirror serving as the “splitting unit” and guiding the split light beams to the PD 14 via the collecting lens 13.

Since the “incident angles in the main-scanning cross section plane” when entering the deflection reflection surface of the polygon mirror are different between the light beam from the light source 1 and the light beam from the light source 1′, the timing chart for APC and optical writing is the same as that of FIGS. 3A and 3B and the same effects as those of the previously-described embodiment can be obtained.

In each embodiment described with reference to FIGS. 1 to 3, the light beams from the light sources 1, 1′ partly “overlap in the main-scanning cross section plane” “on the deflection reflection surface of the polygon mirror” in order for aberration correction and securing effective scanning width.

In this case, in order to obtain a compact monitoring optical system, it is preferable that “the distance from the splitting unit to the deflection reflection surface” is “longer than the distance from the splitting unit to the monitoring unit”.

In this case, as shown in FIG. 4, by arranging “the focus point in which the light is focused or collected in the main scanning direction” via the collecting lens 13 at a position before the light receiving surface of the PD 14 serving as the monitoring unit, the following effects can be achieved.

Specifically, the effective range of the PD 14 can be narrowed, which is advantageous for improving the response property.

Since the light beam on the light receiving surface of the PD 14 is “not excessively focused”, the SN ratio improves. Thereby, even if there is a small defect or dust on the surface, the light intensity can be obtained with high accuracy.

The above-described effects can be enhanced, if the light beams from the respective light sources overlap on the light receiving surface of the PD 14 in the main-scanning direction, as recited in claim 4.

In order to perform APC with high accuracy, it is preferable to eliminate the unnecessary light entering the light receiving surface of the PD 14. However, depending on the layout of the optical system that configures the optical path from each light source to the PD, the monitor light reflected on the PD 14 may be returned to the light sources 1, 1′ and further to the receiving surface of the PD 14.

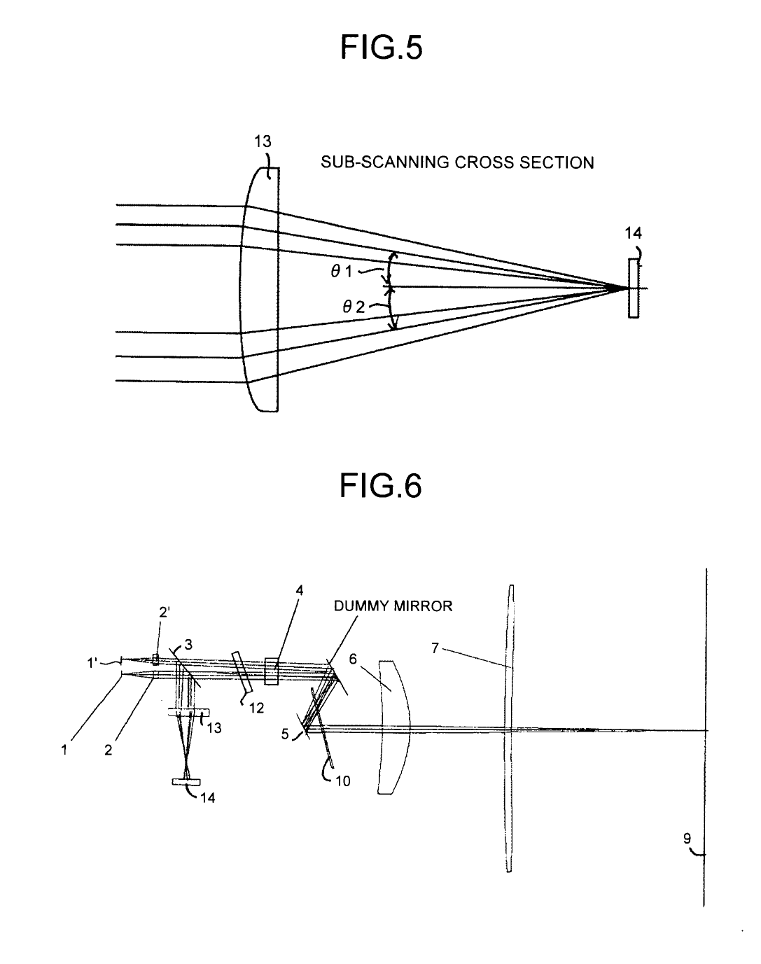

In order to avoid such a returning light by the PD 14, it is sufficient to make different the incident angles of the light beams from the light sources 1 and 1′ in the sub scanning direction cross section plane (a plane parallel to the drawing plane of FIG. 5) when entering the light receiving surface of the PD 14, as illustrated in FIG. 5. For example, the incident angle of the light beam from the light source 1 may be set θ1 and the incident angle of the light beam from the light source 1′ may be set θ2 different from θ1. Thus, it is possible to prevent the returning light to the light source from returning to the PD 14, and thereby improve the SN ratio in the light intensity detection.

FIG. 6 shows another embodiment of the optical scanning device, which is a modification of the embodiment of FIG. 2.

Specifically, the aperture 3 in FIG. 2 is used as a “splitting unit”. The peripheral light entering the periphery of the aperture 3 is guided to the PD 14 via the collecting lens 13. As in each of the above-described embodiments, the light beams from the light sources 1 and 1′ have different incident angles with respect to “the common deflection reflection surface” of the polygon mirror in the main-scanning direction cross section plane. Thus, the same effects as those of each of the above-described embodiments can be obtained. The embodiment in FIG. 6 has an advantage in that there is no loss of the volume of the light beam guided to each station.

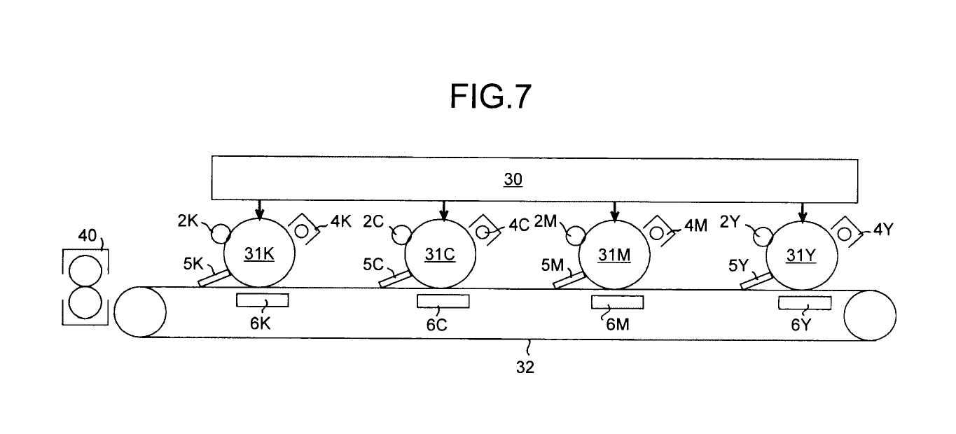

FIG. 7 shows a multi-color-compatible image forming apparatus.

The reference symbols Y, M, C, and K denote yellow, magenta, cyan, and black, respectively. The reference symbols 31Y, 31M, 31C, and 31K denote photosensitive elements on which images of the respective colors are written.

The reference symbols 2Y, 2M, 2C, and 2K denote electric chargers that electrically charge the photosensitive elements. The reference number 30 denotes “a writing unit” and the reference symbols 4Y, 4M, 4C, and 4K denote developers.

The reference symbols 5Y, 5M, 5C, and 5K denote cleaning units, reference symbols 6Y, 6M, 6C, and 6K denote transfer electric chargers, the reference numeral 32 denotes a transfer belt, and the reference numeral 40 denotes a fixing unit.

In FIG. 7, the photosensitive elements 31Y, 31M, 31C, and 31K rotate in the clockwise direction in the figure. The chargers 2Y, 2M, 2C, and 2K, the developers 4Y, 4M, 4C, and 4K, the transfer electric chargers 6Y, 6M, 6C, and 6K, the cleaners 5Y, 5M, 5C, and 5K are arranged around their corresponding photosensitive elements in the order they appear in this sentence and are arranged about the axis of the rotation of the photosensitive elements.

The electric charging members 2Y, 2M, 2C, and 2K uniformly charge the surface of the corresponding photosensitive elements. Between the electric charging members and the developing members 4Y, 4M, 4C, and 4K, electrostatic latent images are formed by optical scanning by the writing unit 30. The electrostatic latent images are developed by the corresponding developers 4Y, 4M, 4C, and 4K and thus toner images of the respective colors are formed on the surfaces of the photosensitive elements.

The formed toner images of the respective colors are sequentially transferred by the transfer electric chargers 6Y, 6M, 6C, and 6K and superimposed on a recording medium that is conveyed by a transfer belt 32 so that a color image is obtained. The color image is then fixed by a fixing unit 40 on the recording medium. The photosensitive elements after the transfer of the toner image are cleaned by the cleaners 5Y, 5M, 5C, and 5K to remove any residual toner and paper particles.

In this example of the image forming apparatus, the image forming units including the photosensitive elements 31Y, 31M, 31C, and 31K correspond to “the stations” described above and “the portions optically scanned by the writing unit 30” on the photosensitive elements correspond to “the optical scanning portions”.

The above-described stations A and B correspond to “the image forming portion of the photosensitive elements 31Y and 31M” and “the image forming portion of the photosensitive elements 31C and 31K”. The embodiments shown in FIGS. 1 to 6 are applied to each of these combinations of two stations to perform optical scanning.

As described above, according to the present invention, a novel optical scanning device can be realized.

In the optical scanning device according to the present invention, as described above, the light beams from two or more light sources, of which light intensities are monitored by the single monitoring unit, enter the common deflecting reflection surface of the polygon mirror as the deflecting unit with different incident angles in the main scanning direction cross section plane, and enter the common monitoring unit at different timings. Thereby, it is possible to detect or monitor the light beams from two or more light sources with a single monitoring unit. Thus, APC can be independently performed for each light source.

By sharing the monitoring unit with different stations, the cost of the optical scanning device can be reduced. Furthermore, by using the PD as a monitoring unit that is shared with the different stations, variations of the PD devices can be prevented in principle, which improves the accuracy of the value of the detected light intensity (light volume).

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical scanning device for an image forming apparatus to form an image by superimposing toner images formed via optical scanning with respect to optical scanning portions on stations, the device comprising:
a light source unit including N surface emitting lasers as light sources each including M light emitting elements, wherein N is an integer more than 1 and M is an integer more than 1;
a deflecting unit that deflects light beams from the light sources with a common deflecting reflection surface;
a scanning optical system that guides the light beams deflected from the common deflecting reflection surface of the deflecting unit onto the optical scanning portions on stations different for each light source in order to form an optical spot with each light beam;
one or more monitoring units that monitor light intensities of the light beams from the light sources corresponding to N surface emitting lasers; and
a splitting unit that splits the light beams, a part of which is to be deflected with the common deflecting reflection surface of the deflecting unit, into split light beams toward one monitoring unit, wherein
the one monitoring unit monitors the light intensities of the light beams from two or more light sources to be deflected with the common deflecting reflection surface of the deflecting unit,
the light beams from two or more light sources of which light intensities are monitored by the one monitoring unit enter the common deflecting reflection surface of the deflecting unit with different incident angles in a main scanning direction cross section plane, and
the light beams from two or more light sources of which light intensities are monitored by the one monitoring unit enter the one monitoring unit at different timings from each other.

2. The optical scanning device according to claim 1, wherein a timing when an Automatic Power Control is started differs between the light sources of which light intensities are monitored by the one monitoring unit.

3. The optical scanning device according to claim 1, wherein
the monitoring unit which monitors the light intensities of the light beams from two or more light sources includes the splitting unit and a common collecting lens that collects the light beams split from the splitting unit, and
the light beams enter a light receiving surface of the one monitoring unit with diverging, after the light beams are collected through the collecting lens before the light receiving surface of the monitoring unit in a main scanning direction.

4. The optical scanning device according to claim 3, wherein
the light beams overlap with each other on the light receiving surface of the monitoring unit, when entering the light receiving surface of the monitoring unit via the collecting lens.

5. The optical scanning device according to claim 3, wherein
the light beams from tow or more light sources of which light intensities are monitored by the one monitoring unit enter the light receiving surface of the one monitoring unit with different incident angles for each light source in a sub scanning direction cross section plane.

6. A multi-color-compatible image forming apparatus to form an image by superimposing toner images formed via optical scanning with respect to optical scanning portions on stations, the apparatus comprising an optical scanning device including:
a light source unit including N surface emitting lasers as light sources each including M light emitting elements, wherein N is an integer more than 1 and M is an integer more than 1;
a deflecting unit that deflects light beams from the light sources with a common deflecting reflection surface;
a scanning optical system that guides the light beams deflected from the common deflecting reflection surface of the deflecting unit onto the optical scanning portions on stations different for each light source in order to form an optical spot with each light beam;
one or more monitoring units that monitor light intensities of the light beams from the light sources corresponding to N surface emitting lasers; and
a splitting unit that splits the light beams, a part of which is to be deflected with the common deflecting reflection surface of the deflecting unit, into split light beams toward one monitoring unit, wherein
the one monitoring unit monitors the light intensities of the light beams from two or more light sources to be deflected with the common deflecting reflection surface of the deflecting unit,
the light beams from two or more light sources of which light intensities are monitored by the one monitoring unit enter the common deflecting reflection surface of the deflecting unit with different incident angles in a main scanning direction cross section plane, and
the light beams from two or more light sources of which light intensities are monitored by the one monitoring unit enter the one monitoring unit at different timings from each other.
